(19) United States
(12) Patent Application Publication
(10) Pub. No.: US 2013/0268540 A1
(43) Pub. Date: Oct. 10, 2013

(54) BIASING GEOCODING OF QUERIES

(71) Applicants: Luuk van Dijk, Zurick (CH); Ingemar Eriksson, Horgen (CH); Ivan Zauharodneu, Zurich (CH); Finnegan Southey, Mountain View, CA (US); Nils Richard Ekwall, Stafa (CH); Fabrice Caillette, Zurich (CH); David Blackman, Rego Park, NY (US)

(72) Inventors: Luuk van Dijk, Zurick (CH); Ingemar Eriksson, Horgen (CH); Ivan Zauharodneu, Zurich (CH); Finnegan Southey, Mountain View, CA (US); Nils Richard Ekwall, Stafa (CH); Fabrice Caillette, Zurich (CH); David Blackman, Rego Park, NY (US)

(21) Appl. No.: 13/442,568

(22) Filed: Apr. 9, 2012

(51) Int. Cl. G06F 17/30

(52) U.S. Cl. 707/748; 707/E17.018; 707/E17.033

(57) ABSTRACT

Methods, systems, and apparatus, including computer programs encoded on computer storage media, for receiving a search query originating from a user device, the search query including a geographic feature name; receiving data identifying one or more candidate point-of-interests, each candidate point-of-interest comprising data that identifies a corresponding candidate geographic entity, each candidate point-of-interest having an initial relevance score; generating one or more biasing boxes, wherein each biasing box defines a geographic region, and each biasing box is defined based on location information associated with the user device or a user using the user device; using the biasing boxes to generate respective adjusted relevance scores for the candidate point-of-interests; selecting a point-of-interest from the one or more candidate point-of-interests according to the respective adjusted relevance scores of the candidate point-of-interests; and using the selected point-of-interest to identify a location relevant to the search query.

### BACKGROUND

This specification relates to ranking search results of search queries submitted to an Internet search engine.

Internet search engines aim to identify resources, e.g., web pages, images, text documents, multimedia content, that are relevant to a user's information needs and to present information about the resources in a manner that is most useful to the user. Internet search engines generally return a set of search results, each identifying a respective resource, in response to a user-submitted query.

### SUMMARY

This specification describes how a system can identify a location relevant to a search query that includes a geographic feature name. The location is selected from candidate geographic features that were identified in response to the search query. In particular, the location is selected based on adjusted relevance scores corresponding to the candidate geographic features. Relevance scores, which indicate a degree of relevance of a respective candidate geographic feature to the search query, are adjusted using one or more biasing boxes. A biasing box defines a geographic region and is defined and generated based on location information associated with a user that submitted the search query. The relevance scores can be adjusted for candidate geographic features that identify a geographic entity that is located within one or more of the generated biasing boxes. In some implementations, a candidate geographic feature having a highest adjusted relevance score is selected as the relevant location.

In general, one innovative aspect of the subject matter described in this specification can be embodied in methods that include the actions of receiving a search query originating from a user of a user device, the search query including a geographic feature name; identifying one or more candidate geographic features that match the received geographic feature name; generating one or more biasing boxes based on location information associated with the user or the user device, without reference to the received search query; scoring each of the one or more candidate geographic features using a scoring function that depends at least in part on the one or more biasing boxes; and selecting a geographic feature from the one or more candidate geographic features based on the scores for each of the one or more candidate geographic features.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can optionally include one or more of the following features. The biasing boxes can be generated at least in part based on a user-provided location. The user-provided location can be a default location preference, a bookmarked location, or a check-in location. A biasing box can be generated at least in part based on a network address associated with the user device. A biasing box can be generated at least in part based on one or more previously received search queries from the user that included a geographic feature name. A biasing box can be generated at least in part based on a geographic location referenced in travel directions previously requested by the user. A biasing box can be generated at least in part based on a geographic feature name referenced in a geotagged photo associated with the user.

Scoring a candidate geographic feature using a scoring function that depends at least in part on a biasing box further includes determining an initial score for candidate geographic feature based on the match between the name of the candidate geographic feature and the received geographic feature name; and increasing the initial score for the candidate geographical feature based on a measure of overlap between a geographic region defined by the biasing box and a geographic region defined by the candidate geographic feature. The measure of the overlap can be based on a ratio of a size of the overlap to a size of the geographic region defined by the geographic feature. The measure of the overlap can be based on a ratio of a size of the overlap to a size of the geographic region defined by the biasing box. The measure of the overlap can based on a ratio of a size of the overlap and a size of a union of the geographic region defined by the biasing box and the geographic region defined by the geographic feature.

Scoring a candidate geographic feature using a scoring function that depends at least in part on a biasing box further includes determining an initial score for candidate geographic feature based on the match between the name of the candidate geographic feature and the received geographic feature name; and increasing the initial score for the candidate geographical feature based on a distance between the geographic feature and the biasing box. The distance between the candidate geographical feature and the biasing box can be measured between a centroid of a geographic area associated with the candidate geographical feature and a centroid of a geographic area defined by the biasing box. The distance between the candidate geographical feature and the biasing box can be measured between points on a boundary of a geographic area defined by the biasing box and a geographic area associated with the candidate geographical feature. The distance between the candidate geographical feature and the biasing box can be measured between a point on a boundary of a geographic area defined by the biasing box and a centroid of a geographic area associated with the candidate geographical feature. The distance between the candidate geographical feature and the biasing box can be measured between a point on a boundary of a geographic area associated with the candidate geographical feature and a centroid of a geographic area defined by the biasing box.

The subject matter described in this specification can be implemented in particular embodiments so as to realize one or more of the following advantages. Relevance scores representing a degree of relevance of a candidate geographic feature to a search query that includes a geographic feature name can be adjusted using biasing boxes that were generated using location information associated with a user or user device that submitted the search query. The adjusted relevance scores can be used to identify a location that is relevant to the search query.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example search system that can identify a location relevant to a search query.

FIG. 2 is a flow diagram of an example process for identifying a location relevant to a search query.

Like reference numbers and designations in the various drawings indicate like elements.

### DETAILED DESCRIPTION

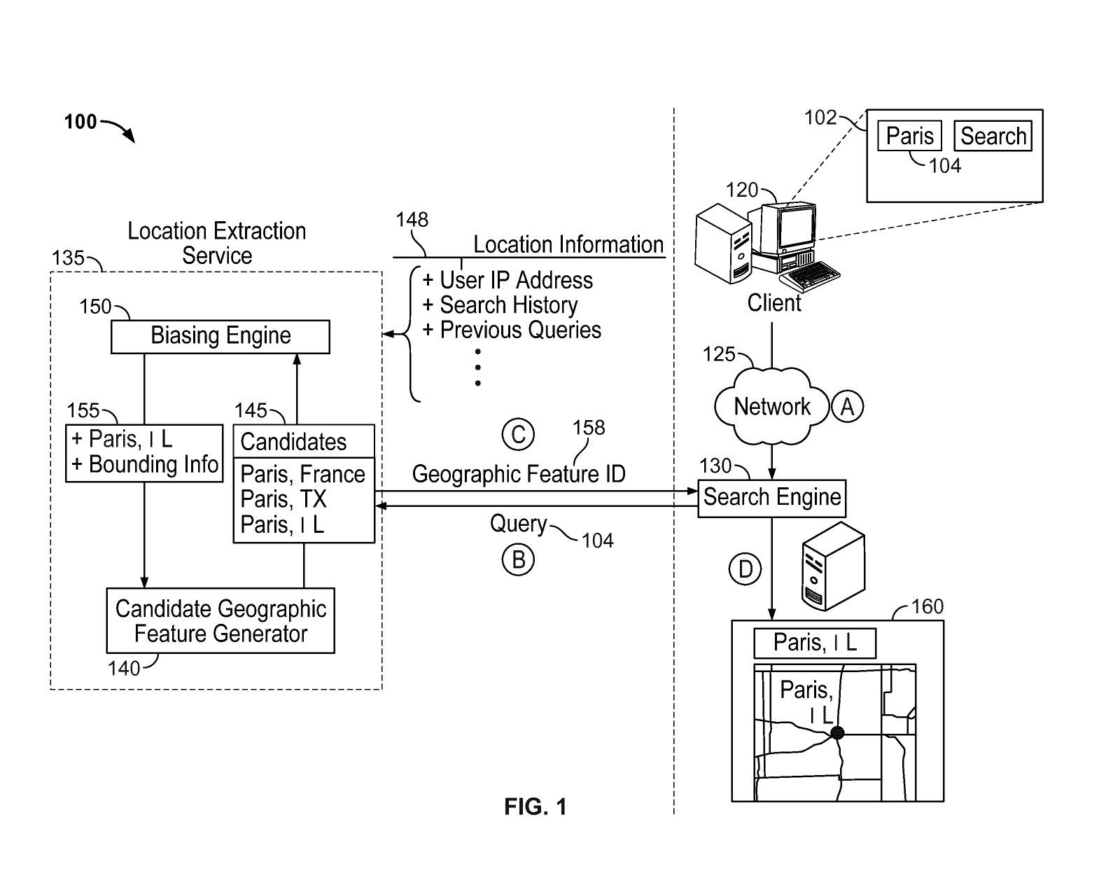

FIG. 1 is a block diagram of an example search system 100 that can identify a location relevant to a search query 104. The search system 100 is an example of an information retrieval system implemented as computer programs on one or more computers in one or more locations, in which the systems, components, and techniques described below can be implemented. The search system 100 includes a search engine 130 and a location extraction service 135.

A user operating a user device 120 enters a query 104 that is or includes a geographic feature name, e.g., “paris,” through a search engine home page 102. The user device 120 can be a computer coupled to the search engine 130 through a data communication network 125, e.g., a local area network (LAN) or wide area network (WAN), e.g., the Internet, or a combination of networks. In some cases, the search system 100 can be implemented on the user device 120, for example, if a user installs an application that performs searches on the user device 120. The user device 120 will generally include a memory, e.g., a random access memory (RAM), for storing instructions and data and a processor for executing stored instructions. The memory can include both read only and writable memory. The user device 120 can be a personal computer of some kind, a cloud client device, a smartphone, or a personal digital assistant. The user device 120 can run an application program, e.g., a web browser, that can interact with the search engine 130 to display web pages, e.g., the search engine home page 102, that provide a user interface to the search engine 130 for the user of the user device 120.

A user can use the user device 120 to submit the query 104 to the search engine 130. When the user submits the query 104, the query 104 may be transmitted through the network 125 to the search engine 130. The search engine 130 submits the query 104 to the location extraction service 135 through the network 125. The location extraction service 135 can implemented as one or more computer program modules installed on one or more computers and includes a candidate geographic feature generator 140 and a biasing engine 150. The candidate geographic feature generator 140 determines that the query 104 includes a geographic feature name, such as a reference to a specific location, e.g., “paris,” and identifies candidate geographic features 145, e.g., “Paris, France,” “Paris, Tex.,” and “Paris, Ill.,” that match the received geographic feature name. As used herein, a geographic feature refers to a named entity having a geographic location. Geographic features can include points-of-interest, businesses, cities, neighborhoods, colloquial districts, counties, countries, continents, postal codes, mountain ranges, lakes, school districts, economic interest zones, and the like. Each geographic feature is associated with a collection of data that can include, for example, a name, address, a geographic region or boundary and a geographic location, e.g., a centroid of the geographic region or boundary. The candidate geographic feature generator 140 can use a scoring function to match the received geographic feature name to one or more candidate geographic features that are stored in a geographic features database. The candidate geographic features 145 are each associated with an initial relevance score indicating a degree of relevance of each candidate geographic feature to the received geographic feature name 104.

The candidate geographic feature generator 140 submits the candidate geographic features 145 to the biasing engine 150. The biasing engine 150 generates one or more biasing boxes that represent geographic regions that may be of interest to the user using the user device 120, independent of the query 104. The biasing boxes can be generated to define a particular area on a map based on location information associated with the user or the user device 120. For example, if the location information indicates that the user or the user device 120 are located in Paris, Tex., then a biasing box is generated to define a geographic region that includes Paris, Tex. As used herein, biasing boxes can be in the shape of a square, a rectangle, an arbitrary convex polygon, an arbitrary polygon, or other shape, e.g., a circle. In some implementations, the generated biasing boxes have a common shape and size, e.g., rectangles of a specified size. In other implementations, the biasing boxes can be of different shapes and sizing dependent upon the location used to generate the biasing boxes or the sources of those locations.

Location information that is used to generate a biasing box can include data that represents geographic coordinates, e.g., latitude and longitude coordinates, for a particular location, e.g., an address, city, state, country, continent, landmark, lake, mountain range, or point-of-interest. The geographic coordinates for the particular location can represent a centroid of a geographic area that includes the location. For example, location information identifying a particular city can include data identifying geographic coordinates for the centroid of a geographic boundary of the particular city. A biasing box for a location associated with the user or user device 120 can be centered on the geographic coordinates of the location.

In some implementations, the location information used to generate biasing boxes is based on explicit user-provided locations. For example, the location information can be based on default location preferences that were specified by a user or locations that were bookmarked by a user in an application program, e.g., a web browser. Similarly, locations provided by a user on social networking sites, e.g., “check-in” locations, and locations in a geotagged image associated with the user, can also be used. Additionally, the location information can be based on locations referenced in an address book associated with the user.

Location information can also be based on other types of user data. For example, the location information can be based on a search history of the user or of the user device 120. For example, the location information can be based on queries that were previously submitted and that include a name of or a reference to a specific location or geographic features such as a point-of-interest. Further, the location information can be based on a user's current, or previously viewed, map viewport. A map viewport is a geographic region displayed by a map interface or an image capture device, e.g., a camera. For example, a biasing box generated for a particular map viewport can be used to adjust relevance scores for candidate geographic features that identify geographic entities that are located within the map viewport. Further, the user's travel paths, e.g., driving directions, as obtained from queries submitted to a map search system or from a GPS-based navigation system can also be used as a source of location information. For example, a user request for driving directions from San Francisco, Calif. to Las Vegas, Nev. can be used to generate a biasing box defining a geographic region for San Francisco, Calif. and a biasing box defining a geographic region for Las Vegas, Nev.

Additionally, the location information can be based on a derived location for the user or the user device 120. For example, the location can be derived from a geocoded network address, such as a geocoded Internet Protocol (IP) address, of the user device 120. In another example, the location of the user device 120 can be derived from GPS signals, or triangulation of cell tower or Wi-Fi access point signals. Further, the location can also be determined from previously derived locations for the user or the user device 120, e.g., based on a previously geocoded IP address of user device 120.

Other sources of location information used to generate biasing boxes include country code or top-level domain information obtained from URLs of websites accessed by the user or user device 120, and country or location information derived from mobile carrier data. For example, a biasing box generated for a particular country can be used to adjust relevance scores for candidate geographic features that identify geographic entities that are located within the particular country. Additionally, location information can be based on locations that were predicted based on user routing models, e.g., locations or travel routes provided to the user or the user device 120 over a particular time period.

A user or user device can be identified using conventional techniques, e.g., based on a user being logged into a user account, an Internet Protocol address associated with the user device being used by user, or by using information provided by the user device, e.g., an Internet cookie. Data concerning users can optionally be anonymized.

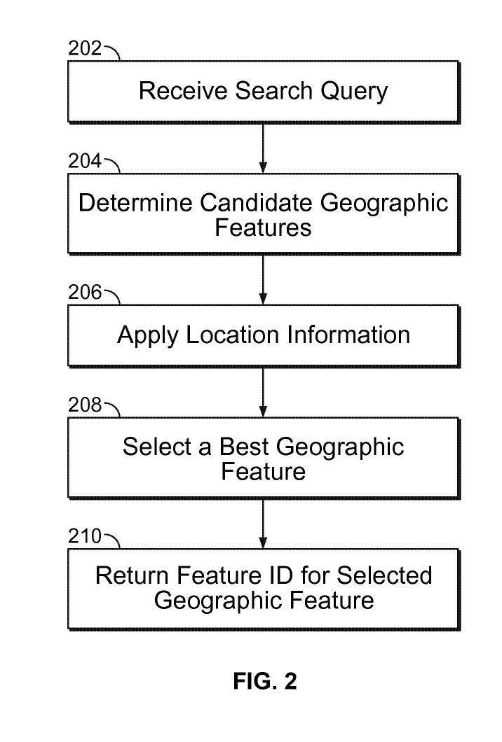

The biasing engine 150 adjusts the relevance score for each candidate geographic feature having a geographic area that at least partially overlaps the geographic area of the generated biasing boxes, as described in reference to FIG. 2. The biasing engine 150 selects a geographic feature 155 from the candidate geographic features 145 according to the respective adjusted relevance scores of the candidate geographic features 145. For example, the biasing engine 150 can select the geographic feature 155 for having an adjusted relevance score that exceeds the adjusted relevance score for the remaining geographic features 145. The location extraction service 135 can provide an identifier 158 for the selected geographic feature 155 to the search engine 130.

The search engine 130 can use the selected geographic feature identifier 158 to obtain and provide map data to the user device 120 for presentation to the user. For example, the search engine 130 can use the selected geographic feature identifier 158 to identify a geographic location on a map interface 160 that is displayed by a web browser running on the user device 120.

FIG. 2 is a flow diagram of an example process for identifying a location or geographic features such as a point-of-interest relevant to a search query. For convenience, the process 200 will be described as performed by a system including one or more computing devices. For example, a search system 100, as described in reference to FIG. 1, can be used to perform the process 200.

The system receives a search query originating from a user device; the search query is or includes a geographic feature name (202). The geographic feature name can be a name of a specific location, e.g., “paris,” or a reference to a specific location, e.g., “NYC,” or a name of a point-of-interest, e.g., “Museum of Modern Art.”

In some cases, a query can include terms that, depending on the context, may or may not be geographic names or references to specific locations. For example, a query can include a term “mobile,” which may be a reference to a mobile device or a specific location, e.g., Mobile, Ala. In such cases, biasing boxes that were generated using location information associated with a user or user device that submitted the search query can be used to disambiguate such terms. For example, relevance scores for geographic features that identify geographic entities located in proximity to Mobile, Ala. can be adjusted for users that are located in Alabama. In some implementations, the biasing boxes are used to determine that the query term is a geographic name or reference to a specific location.

The system identifies one or more candidate geographic features that match the received geographic feature name (204). In some implementations, the system identifies the one or more candidate geographic features as features whose names match the received geographic feature name. For example, a candidate geographic feature name can be said to match the received geographic feature name if it is within a predetermined string edit distance of the received geographic feature name. Each candidate geographic feature includes an initial relevance score that indicates a degree of relevance of the corresponding candidate geographic feature to the received geographic feature name. For example, for a query that includes the geographic feature name “nyc,” the system can determine that “New York City, N.Y.” is a candidate geographic feature with an initial relevance score of 0.9.

The system applies location information to adjust relevance scores of the candidate geographic features (206). The system adjusts relevance scores using one or more biasing boxes that were generated using the location information associated with the user or user device, as described in reference to FIG. 1.

In some implementations, an adjusted relevance score for a geographic feature is generated by increasing the initial relevance score for the geographic feature by a particular factor when a measure of the overlap between a geographic region defined by a biasing box and a geographic region defined by the geographic feature satisfies a threshold value.

The measure of overlap can vary depending on the implementation. For example, the measure can be based on a percentage of the overlap with respect to the size of the geographic region defined by the geographic feature. In some implementations, the measure of the overlap is determined by computing a ratio of a size of the overlap and the size of the geographic region defined by the geographic feature. For example, the system can adjust the relevance score for a geographic feature by a factor, e.g., 1.1, 1.2, or 1.3, if the percentage of overlap with respect to the size of the geographic region defined by the geographic feature satisfies a threshold of 60 percent.

In another example, the measure of overlap can be based on a percentage of the overlap with respect to the size of the geographic region defined by the biasing box. In some implementations, the measure of the overlap is determined by computing a ratio of a size of the overlap to a size of the geographic region defined by the biasing box. For example, the system can adjust the relevance score for a geographic feature by a factor if the percentage of overlap with respect to the size of the geographic region defined by the biasing box satisfies a threshold of 45 percent.

In instances where the geographic region defined by the geographic feature does not overlap with the geographic region defined by the biasing box, the relevance score can be adjusted by computing a distance between the geographic region defined by the geographic feature and the geographic region defined by the biasing box. In some implementations, an adjusted relevance score for a geographic feature is generated by increasing the initial relevance score for the geographic feature by a particular value based a distance between the geographic feature and the biasing box. One example ratio for determining the particular value can be expressed as:

$$\frac{1}{{x}^{2}}$$

where x is the distance between the geographic feature and the biasing box. The initial score for a candidate geographic feature can be increased by adding the particular value to the initial score, or by multiplying the initial score by one plus the particular value, or by other suitable combinations.

The distance between a geographic feature and a biasing box can be determined in any number of ways. For example, it can be the distance between a centroid of the biasing box and a centroid for the geographic feature. Alternatively, it can be the closest distance between points on the boundary of the biasing box and the geographical feature. Likewise, it can be the closest distance between a point on the boundary of the biasing box and the centroid of the geographical feature, or a closest distance between a point on the boundary of the geographical feature and the centroid of the biasing box.

Relevance scores of the candidate geographic features can also be adjusted based on relationships between locations defined by the candidate geographic features and the generated biasing boxes. For example, a candidate geometric feature defining an entity on a major route between two biasing boxes may be given a higher relevance score. Similarly, candidate geographic features with locations within multiple biasing boxes can be given a higher relevance score.

Multiple biasing boxes can be used to adjust the initial scores of the candidate geographical features either separately or together. For example, each of two or more biasing boxes can be separately used to compute a different adjustment value for the initial score for a candidate geographical feature, and the separately determined adjustments can be combined to determine a net adjustment for the feature. Alternatively, the two or more biasing boxes can be combined, and the combined biasing box can be used to determine an adjustment to the initial score of a candidate geographic feature. For example, two biasing boxes can be combined by taking an intersection or a union of the geographic areas covered by the two boxes.

Once the scores for the candidate geographic features have been adjusted, the system selects a best geographic feature (208). The system can select a candidate geographic feature having a highest adjusted relevance score as the selected geographic feature that best matches the geographic feature name received in the search query.

The system returns a geographic feature identifier that identifies the selected geographic feature (210). The geographic feature identifier can be used to identify the particular geographic entity on a map interface.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, the method comprising:
receiving a search query originating from a user of a user device, the search query including a geographic feature name;
identifying one or more candidate geographic features that match the received geographic feature name;
generating one or more biasing boxes based on location information associated with the user or the user device, without reference to the received search query;
scoring each of the one or more candidate geographic features using a scoring function that depends at least in part on the one or more biasing boxes; and
selecting a geographic feature from the one or more candidate geographic features based on the scores for each of the one or more candidate geographic features.

2. The method of claim 1, wherein at least one of the biasing boxes is generated at least in part based on a user-provided location.

3. The method of claim 2, wherein the user-provided location is a default location preference, a bookmarked location, or a check-in location.

4. The method of claim 1, wherein at least one biasing box is generated at least in part based on a network address associated with the user device.

5. The method of claim 1, wherein at least one biasing box is generated at least in part based on one or more previously received search queries from the user that included a geographic feature name.

6. The method of claim 1, wherein at least one biasing box is generated at least in part based on a geographic location referenced in travel directions previously requested by the user.

7. The method of claim 1, wherein at least one biasing box is generated at least in part based on a geographic feature name referenced in a geotagged photo associated with the user.

8. The method of claim 1, wherein scoring a candidate geographic feature using a scoring function that depends at least in part on a biasing box further comprises:
determining an initial score for candidate geographic feature based on the match between the name of the candidate geographic feature and the received geographic feature name; and
increasing the initial score for the candidate geographical feature based on a measure of overlap between a geographic region defined by the biasing box and a geographic region defined by the candidate geographic feature.

9. The method of claim 8, wherein the measure of the overlap is based on a ratio of a size of the overlap to a size of the geographic region defined by the geographic feature.

10. The method of claim 8, wherein the measure of the overlap is based on a ratio of a size of the overlap to a size of the geographic region defined by the biasing box.

11. The method of claim 8, wherein the measure of the overlap is based on a ratio of a size of the overlap and a size of a union of the geographic region defined by the biasing box and the geographic region defined by the geographic feature.

12. The method of claim 1, wherein scoring a candidate geographic feature using a scoring function that depends at least in part on a biasing box further comprises:
determining an initial score for candidate geographic feature based on the match between the name of the candidate geographic feature and the received geographic feature name; and
increasing the initial score for the candidate geographical feature based on a distance between the geographic feature and the biasing box.

13. The method of claim 12, where the distance between the candidate geographical feature and the biasing box is measured between a centroid of a geographic area associated with the candidate geographical feature and a centroid of a geographic area defined by the biasing box.

14. The method of claim 12, where the distance between the candidate geographical feature and the biasing box is measured between points on a boundary of a geographic area defined by the biasing box and a geographic area associated with the candidate geographical feature.

15. The method of claim 12, where the distance between the candidate geographical feature and the biasing box is measured between a point on a boundary of a geographic area defined by the biasing box and a centroid of a geographic area associated with the candidate geographical feature.

16. The method of claim 12, where the distance between the candidate geographical feature and the biasing box is measured between a point on a boundary of a geographic area associated with the candidate geographical feature and a centroid of a geographic area defined by the biasing box.

17. A system comprising:
one or more computers and one or more storage devices storing instructions that are operable, when executed by the one or more computers, to cause the one or more computers to perform operations comprising:
receiving a search query originating from a user of a user device, the search query including a geographic feature name;
identifying one or more candidate geographic features that match the received geographic feature name;
generating one or more biasing boxes based on location information associated with the user or the user device, without reference to the received search query;
scoring each of the one or more candidate geographic features using a scoring function that depends at least in part on the one or more biasing boxes; and
selecting a geographic feature from the one or more candidate geographic features based on the scores for each of the one or more candidate geographic features.

18. The system of claim 17, wherein at least one biasing box is generated based on at least one of the following locations: a user-provided location, a default location preference, a bookmarked location, a check-in location, a network address associated with the user device, one or more previously received search queries from the user that included a geographic feature name, a geographic location referenced in travel directions previously requested by the user, or a geographic feature name referenced in a geotagged photo associated with the user.

19. The system of claim 17, wherein scoring a candidate geographic feature using a scoring function that depends at least in part on a biasing box further comprises:
determining an initial score for candidate geographic feature based on the match between the name of the candidate geographic feature and the received geographic feature name; and
increasing the initial score for the candidate geographical feature based on a measure of overlap between a geographic region defined by the biasing box and a geographic region defined by the candidate geographic feature.

20. The system of claim 19, wherein the measure of overlap is based on at least one of the following measurements: a ratio of a size of the overlap to a size of the geographic region defined by the geographic feature, a size of the overlap to a size of the geographic region defined by the biasing box, or a size of the overlap and a size of a union of the geographic region defined by the biasing box and the geographic region defined by the geographic feature.

21. The system of claim 17, wherein scoring a candidate geographic feature using a scoring function that depends at least in part on a biasing box further comprises:
determining an initial score for candidate geographic feature based on the match between the name of the candidate geographic feature and the received geographic feature name; and
increasing the initial score for the candidate geographical feature based on a distance between the geographic feature and the biasing box.

22. The system of claim 21, wherein the distance between the candidate geographical feature and the biasing box is measured based on at least one of the following distances: a distance between a centroid of a geographic area associated with the candidate geographical feature and a centroid of a geographic area defined by the biasing box, a distance between the candidate geographical feature and the biasing box is measured between points on a boundary of a geographic area defined by the biasing box and a geographic area associated with the candidate geographical feature, a distance between the candidate geographical feature and the biasing box is measured between a point on a boundary of a geographic area defined by the biasing box and a centroid of a geographic area associated with the candidate geographical feature, or a distance between the candidate geographical feature and the biasing box is measured between a point on a boundary of a geographic area associated with the candidate geographical feature and a centroid of a geographic area defined by the biasing box.
